(19) United States
(12) Patent Application Publication
(10) Pub. No.: US 2023/0378563 A1
(43) Pub. Date: Nov. 23, 2023

(54) Production of a Cell Casing of a Battery Cell, and Cell Casing

(71) Applicant: Bayerische Motoren Werke Aktiengesellschaft, Muenster (DE)

(72) Inventors: Simon LUX, Muenster (DE); Lydia TERBORG, Muenster (DE)

(21) Appl. No.: 18/031,023

(22) PCT Filed: Sep. 29, 2021
(86) PCT No.: PCT/EP2021/076775

§ 371 Date: Apr. 10, 2023

(30) Foreign Application Priority Data
Oct. 19, 2020 (DE) 10 2020 127 408.4

(51) Int. Cl. H01M 10/625; H01M 10/615; B60L 50/64; B60L 58/27

(52) U.S. Cl. CPC H01M 10/625; H01M 10/615; B60L 50/64; B60L 58/27; H01M 2220/20

(57) ABSTRACT

A method for producing a cell casing for a battery cell having an integrated cell heater includes applying a cell heater to a first side of a first metallic layer, and, after the applying, folding a composite stack comprising at least the first metallic layer and the cell heater, such that a second side of the first metallic layer forms an inside of the cell casing. A battery has a plurality of battery cells which each have a cell casing of this kind, where the second metal layers of the cell casings are electrically interconnected. An electrically operated vehicle has at least one battery including at least one battery cell which comprises a cell casing of this kind and/or a battery of this kind.

### BACKGROUND AND SUMMARY

The invention relates to a method for producing a cell casing for a battery cell. The invention also relates to a battery having multiple battery cells, which each have a cell casing thus produced. The invention also relates to an at least partially electrically driven vehicle, having at least one battery having at least one battery cell which has such a cell casing. The technology is particularly advantageously applicable to electric vehicles and plug-in hybrid vehicles.

In a lithium-ion battery cell, a cell casing, which typically includes aluminum, can be interconnected in various ways with the live parts. The cell casing is classically connected with or without ohmic resistance to a positive terminal of a voltage source in order to ensure the passivation of the interior aluminum surface by the electrolytes. In another embodiment, the cell casing is completely isolated from live mechanical parts, and an electrical potential at the cell is provided externally. However, both embodiments have the effect that the potential applied to the cell casing is also present on its outside. However, this represents a challenge with respect to a modular structure of a battery having multiple battery cells, since in this case an electrical insulation of the battery cells from one another is necessary to avoid short-circuits between the battery cells. Presently, the electrical insulation is achieved by a separate electrically insulating film which encloses the cell or lacquering of the cell. However, both are costly and make it more difficult to detect electrical faults or changes on the cell casing.

Furthermore, providing a heater on the module or storage device level to warm up an energy storage device having multiple battery cells is known. This heater is sometimes arranged far away from the battery cells and therefore restricted in its effectiveness.

It is the object of the present disclosure to at least partially overcome the disadvantages of the prior art and in particular to provide an inexpensively implementable option for providing an effectively heatable electrical storage cell (“battery cell”).

This object may be achieved according to the features of the independent claims. Preferred embodiments can be inferred in particular from the dependent claims.

The object may be achieved by a method for producing a cell casing for a battery cell having an integrated cell heater, in which a layer-type planar cell heater is applied to a flat side of a “first” metallic layer and then the layer or composite stack, which has at least the first metallic layer and the cell heater, is folded so that the other flat side of the metallic layer forms an inside of the cell casing.

Such a cell casing may advantageously be produced particularly easily by folding (for example after prior stamping), especially in comparison to deep drawing. Moreover, it is thus made possible to apply the planar cell heater particularly easily to the first metallic layer. In addition, the planar cell heater is mechanically stressed only slightly during folding, which keeps a risk of its damage during the production of the cell casing low.

A further advantage may be achieved by the integration of the cell heater in the cell casing, because a particularly effective heating capability may thus be achieved.

It is a refinement that the abutting edges of the folded cell casing may be connected to one another, in particular in a leak-tight manner. The abutting edges can be welded, for example, in particular by laser welding. In general, a folding procedure can be understood hereinafter as a folding and welding procedure, if not indicated otherwise from the context.

The battery cell can be, for example, a lithium-ion cell.

The composite stack can also be designated as a ply or layer stack.

The first metallic layer can be a metal plate or can have been isolated from a metal plate. It is in particular flat or a flat component before the folding. Such flat components typically have two flat sides, which are separated from one another by a peripheral edge. The first metallic layer may comprise, for example, aluminum.

The layer-type planar cell heater is attached before the folding to the provided flat side of the first metallic layer, for example, by adhesive bonding, printing, paste application, etc. The cell heater can be prefinished or alternatively can first be produced on the first metallic layer. For example, the cell heater can be provided as a prefinished component which has an electrically insulating film—for example made of a polymer—on which one or more resistor tracks (“heating conductor tracks”) are arranged. In one refinement, the cell heater can be adhesively bonded or welded with its film, for example, on a metallic layer.

In one embodiment, before the folding, a second metallic layer is arranged on the side of the cell heater facing away from the first metallic layer. This results in the advantage that an electrical potential may thus be defined over a large area on the outside of the cell casing. The cell heater may thus also be mechanically and chemically protected particularly easily. The composite or layer stack which is to be folded or is folded thus also comprises the second metallic layer. The second metallic layer may comprise the same material as the first metallic layer, for example aluminum, or can alternatively comprise another material, for example steel. The cell heater may be arranged between the first metallic layer and the second metallic layer, which can also be designated as a “sandwich composite.”

The object may also be achieved by a cell casing for a battery cell having an integrated cell heater, wherein the cell casing has been produced according to a method as described above. The cell casing can be designed similarly to the method, and vice versa, and may have the same advantages.

The object may be achieved in particular by a cell casing in which a layer-type planar cell heater is attached to a flat side of a first metallic layer and a composite stack comprising at least the first metallic layer and the cell heater is folded so that another flat side of the first metallic layer forms an inside of the cell casing.

In one embodiment, the cell heater has a heating layer having at least one planar resistance heating conductor. A resistance heating conductor is advantageously easily operable and may be formed to be thin and flexible. The resistance heating conductor may be, for example, a thin-film or thick-film heating conductor. The resistance heating conductor can be provided as a heating conductor track, for example as a looped, in particular meandering, heating conductor track. The heating conductor track can have been produced, for example, by printing, blade coating, spraying, electroplating, etc.

In one embodiment, the cell heater has at least one electrically insulating film which is arranged on a respective side of the heating layer. An electrical insulation of the heating layer is thus achieved on this side. The at least one electrically insulating film can also advantageously be used for pre-finishing, positioning, and fastening of the cell heater. In one refinement, the cell heater has an electrically insulating film on only one side of the heating layer. In one refinement, the cell heater has an electrically insulating film in each case on both sides of the heating layer.

In one embodiment, the cell heater rests directly on the first metallic layer. This results in the advantage of a particularly low thermal resistance between the heating layer of the cell heater and the first metallic layer and thus particularly effective heating of the cell casing. The cell heater can in one refinement have at least one heating conductor track applied to an electrically insulating film, where the at least one heating track is electrically separated from the first metallic layer by the film. In a variant, the heating layer can be electrically connected using a pole or terminal to the first metallic layer.

In one embodiment, the cell heater rests on the first metallic layer separated by an electrically insulating layer (“electrical insulation layer”). A particularly reliable potential separation between heating layer and first metallic layer can thus be achieved. The electrical insulation layer can be, for example, a flexible polymer film, for example made of polyethylene. The electrically insulating layer in particular does not represent a component of a prefinished cell heater, but rather can be a layer introduced independently into the composite stack. In one refinement, the electrically insulating layer has at least one property different from the film of the cell heater, for example, a different material and/or a different thickness. Different insulating properties can thus advantageously be combined with one another, for example, a different fire resistance, breakdown strength, etc.

In one embodiment, an electrical insulation layer is arranged on the side of the cell heater facing away from the first metallic layer. A particularly reliable electrical insulation of the heating layer of the cell heater to the outside or, if the second metallic layer is present, in relation thereto is thus advantageously achieved.

In one embodiment, the cell casing has a folded composite made up of an inside first metallic layer, an outside second metallic layer, and a cell heater arranged between them, wherein the cell heater is electrically insulated in relation to the first metallic layer and is electrically connected using a terminal to the second metallic layer. The other terminal of the heating layer can be led out of the cell casing, for example upward. This embodiment results in the advantage that multiple cell casings may be electrically connected together particularly easily, in particular while avoiding a conductor foil.

The object may also be achieved by an energy storage device or a battery having multiple—in particular modularly constructed—battery cells, each of which has a cell casing as described above, wherein the second metallic layers of the cell casings are electrically connected to one another. The battery can be designed similarly to the method and the cell casing, and vice versa, and may have the same advantages.

The object may also be achieved by an electrically driven vehicle (fully electrically operated vehicle or hybrid vehicle) having at least one electrical energy storage device having at least one battery cell, which has a cell casing as described above. The application in plug-in hybrid vehicles is particularly advantageous, especially for heating the cell casings before or during a journey in winter.

The above-described properties, features, and advantages of this technology and the manner in which they are achieved will become clearer and more comprehensible in conjunction with the following schematic description of an exemplary embodiment, which is explained in more detail in conjunction with the drawings.

### BRIEF DESCRIPTION OF THE DRAWINGS

FIG. 1 shows, in an upper partial image, a top view of a planar composite according to one exemplary embodiment before a folding procedure and, in a lower partial image, a side sectional view of this composite;

FIG. 2 shows, in an upper partial image, a top view of a cell casing which has been produced by folding the composite from FIG. 1 and, in a lower partial image, a side sectional view of the cell casing;

FIG. 3 shows, as a sectional illustration in a side view, a detail from a planar composite according to a further exemplary embodiment; and

FIG. 4 shows, as a sectional illustration in a side view, a cell casing which has been produced by folding of the composite according to the exemplary embodiment from FIG. 3;

FIGS. 5 to 7 show, as a sectional illustration in a side view, a cell casing which has been produced by folding of composites according to still further exemplary embodiments; and

FIG. 8 shows, as a sectional illustration in a side view, a battery having cell casings according to FIG. 7 of multiple electrically interconnected battery cells.

### DETAILED DESCRIPTION OF THE DRAWINGS

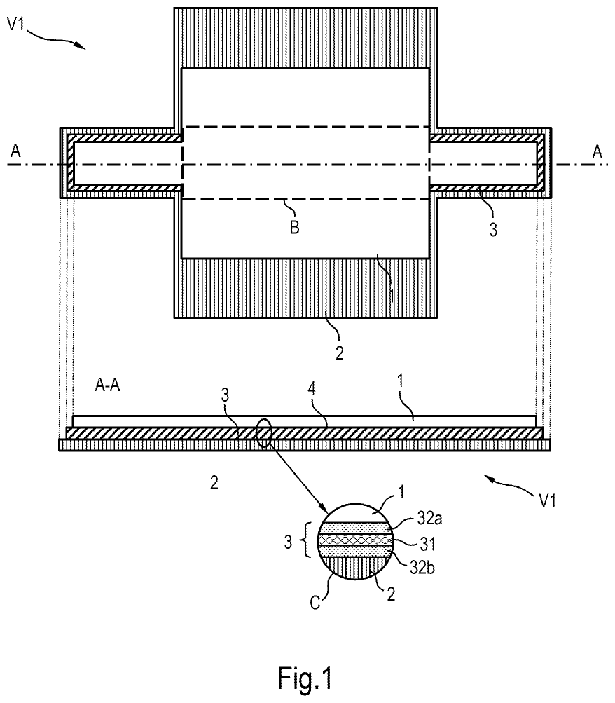

FIG. 1 shows, in an upper partial image, a top view of a planar composite stack V1 before a folding procedure and, in a lower partial image, a sectional side view of the composite stack V1 along a sectional plane A-A shown in the upper partial image. The composite stack V1 has a first metallic layer 1 and a second metallic layer 2, between which a thin, planar or flatly extended cell heater 3 is arranged. The cell heater 3 is thus attached to a flat side 4 of the first metallic layer 1 which faces toward the second metallic layer 2.

The metallic layers 1 and 2 can comprise aluminum, for example. The cell heater 3 can have, for example, a heating layer 31 having at least one heating conductor track, which is covered on both sides by an electrically insulating film 32a or 32b in each case, as shown in detail C. The films 32a and 32b can be, for example, flexible films made of polyethylene.

The cell heater 3 can be operated so that an electric current is sent through the at least one heating conductor track, which heats up the heating conductor track due to ohmic losses. For the connection of a heating conductor track and thus the heating layer 31 to a voltage source, it can have corresponding terminals or contacts at both ends, for example contact fields.

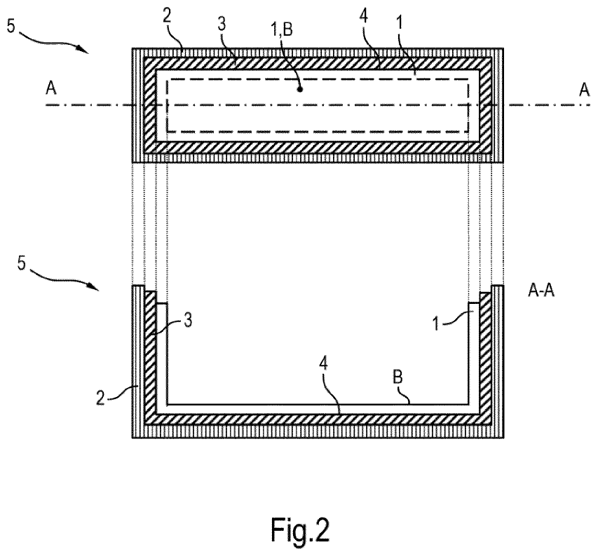

FIG. 2 shows, in an upper partial image, a top view of a cell casing 5, which has been produced by folding the composite stack V1 along the sides of a central bottom area B, and, in a lower partial image, a sectional side view of the cell casing 5 along the sectional plane A-A shown in the upper partial image. The flat side of the first metallic layer 1 facing away from the cell heater 3 forms the inside of the cell casing 5.

The folding can be implemented, for example, by folding near the edges. After folding, the abutting edges of the cell casing 5 may be connected to one another, in particular by material bonding, for example by welding, in particular laser welding. The cell casing 5 thus folded is open on top, wherein the open side can be covered by a cover or a cover assembly (not shown).

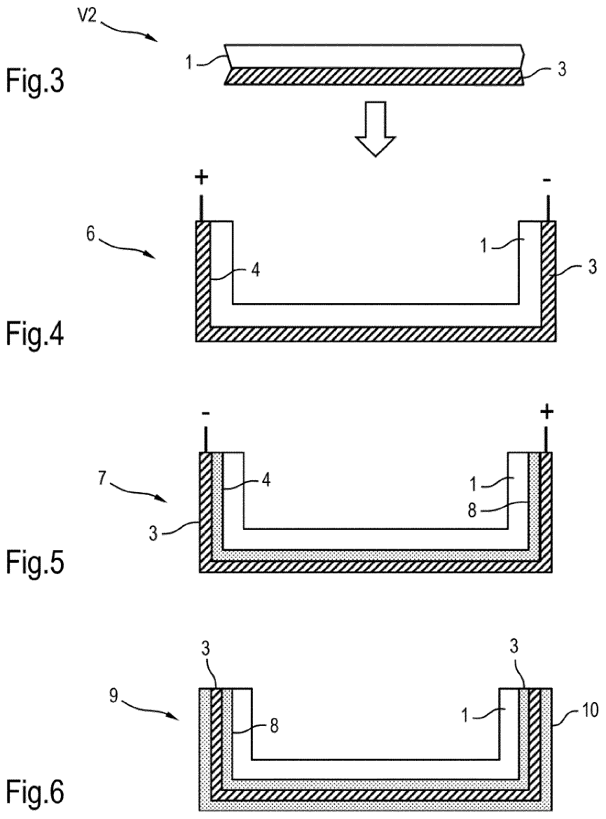

FIG. 3 shows a sectional illustration in a side view of a detail from a planar composite stack V2. In contrast to the composite stack V1, the composite stack V2 does not have a second metallic layer 2, but rather comprises here a cell heater 3 applied to a flat side of the first metallic layer 1, which can be designed, for example, as shown in FIG. 1, detail C. FIG. 4 shows a side view sectional illustration of a cell casing 6, which has been produced by folding of the composite stack V2 from FIG. 3, so that an inside of the first metallic layer 1 represents an inside of the cell casing 6.

In a possible connection variant, the two electrical terminals of the heating layer 31 or of the cell heater 3 may be led out of the cell casing 6 and can be connected as indicated, for example, to a positive pole and a negative pole of a DC voltage source. Alternatively, one of the two terminals could be connected to the first electrical layer 1.

FIG. 5 shows a sectional illustration in a side view of a cell casing 7, which has been produced by means of folding of a composite stack made up of a first metallic layer 1 and a cell heater 3 applied on a flat side thereon. In addition to the cell casing 6, a planar electrical insulation layer 8, for example a flexible film made of polyethylene, is arranged between the first metallic layer 1 and the cell heater 3.

The cell heater 3 can be designed, for example, as shown in FIG. 1, detail C. Alternatively, the insulating film 32a facing toward the first metallic layer 3 can be omitted in the cell heater 3. In the latter case, the electrical insulation of the heating layer 31 in relation to the first metallic layer 1 may be effectuated by only the insulation layer 8.

A connection variant is also shown here in which the two electrical terminals of the cell heater 3 are led out of the cell casing 6 and connected as indicated to a positive pole and a negative pole of a DC voltage source.

FIG. 6 shows a sectional illustration in a side view of a cell casing 9, which, in contrast to the cell casing 7, has two planar electrical insulation layers 8 and 10, for example flexible films made of polyethylene, between which the cell heater 3 is arranged. The layer sequence of the associated ply or layer stack thus reads: first metallic layer 1, first insulation layer 8, cell heater 3, second insulation layer 10.

The cell heater 3 can be designed, for example, as shown in FIG. 1, detail C. Alternatively, the insulating film 32a facing toward the insulation layer 8 and/or the insulating film 32b facing toward the insulation layer 10 can be omitted in the cell heater 3.

In refinements, the cell casings 6, 7, and 9 can also have an outside second metallic layer 2, similarly to the cell casing 5.

In one possible connection variant (not shown), the two electrical terminals of the cell heater 3 can also be led out of the cell casing 7 here.

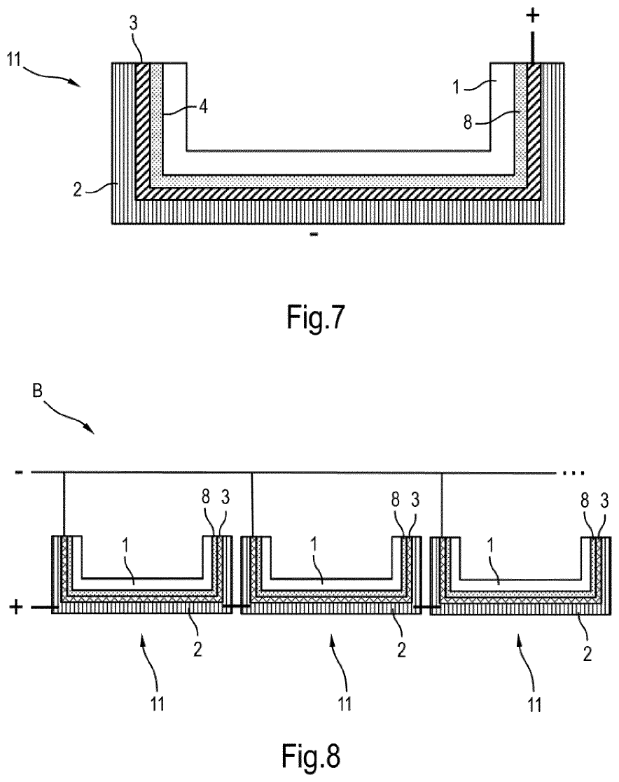

FIG. 7 shows a side view sectional illustration of a cell casing 11, which has the first metallic layer 1 and the second metallic layer 2, between which an insulation layer 8 and a cell heater 31 are arranged, in such a way that the insulation layer 8 rests on the first, inside metallic layer 1 and the cell heater 31 rests on the second, outside metallic layer 2.

The cell heater 3 can be designed, for example, as shown in FIG. 1, detail C. Alternatively, in the cell heater 3, the insulating film 32a facing toward the insulation layer 8 can be omitted. In one refinement, a terminal of the heating layer 31 of the cell heater 3 is electrically connected to the second metallic layer 2, for example soldered or welded. Another terminal of the heating layer 31 can be led out of the cell casing 11, in particular upward.

In general, even more than the layers shown above can be integrated in the cell casings, for example multiple heating layers, at least one further layer of different functionality, for example a protective layer, etc.

In the possible connection variant shown, one of the two terminals can be led directly upward out of the cell casing 11 starting from the cell heater 3, as indicated by the exemplary terminal at a positive pole of a voltage source, while the other terminal is connected to the second electrical layer 2. Since the first metallic layer 1 is electrically insulated in relation to the heating layer 31, the second electric layer 2, which is itself electrically conductive, can be set at the other voltage level of the voltage supply, as indicated here by the minus sign. Alternatively (not shown), the two electrical terminals of the cell heater 3 can also be led out of the cell casing 11 here.

FIG. 8 shows a side view sectional illustration of an energy storage device or a battery E having cell casings 11 of multiple electrically interconnected battery cells.

In this battery B, the heating layers 31 are connected using one electrical terminal directly to the associated exterior second metallic layers 2, while the other terminals are led out upward. Since the first metallic layers 1 are electrically insulated in relation to the heating layer 31, the second metallic layers 2 can be electrically connected (for example in series) and thus form one of the two conductors of the heating layers 31. The other conductor is connected to the terminals of the heating layers 31 led out upward. In contrast to FIG. 7, the positive pole is connected here to the second electrical layers 2, while the terminals led out upward are connected to the negative pole. One advantage of such an arrangement is a possible saving of a conductor foil.

Of course, the present invention is not restricted to the exemplary embodiment shown.

For instance, the selection of the voltage levels and polarities and the selection of a DC or AC voltage for operating a cell heater 3 can fundamentally be selected as desired. A pulse width modulation (PWM) feed is also possible.

In general “a”, “an” etc. can be understood as one or a plurality, in particular in the meaning of “at least one” or “one or more” etc., as long as this is not explicitly precluded, for example by the expression “precisely one”, etc.

A numeric specification can also comprise precisely the specified number and also a typical tolerance range, as long as this is not explicitly precluded.

### LIST OF REFERENCE SIGNS

1 first metallic layer
2 second metallic layer
3 cell heater
4 flat side of the first metallic layer
5 cell casing
6 cell casing
7 cell casing
8 planar electrical insulation layer
9 cell casing
10 planar electrical insulation layer
11 cell casing
31 heating layer of the cell heater
32a electrically insulating film of the cell heater
32b electrically insulating film of the cell heater
A sectional plane
R bottom area
C detail
E battery
V1 composite stack
V2 composite stack

1-11. (canceled)

12. A method for producing a cell casing for a battery cell having an integrated cell heater, the method comprising:
applying a cell heater to a first side of a first metallic layer; and
after the applying, folding a composite stack comprising at least the first metallic layer and the cell heater, whereby a second side of the first metallic layer forms an inside of the cell casing.

13. The method according to claim 12, further comprising, prior to the folding, arranging a second metallic layer on a side of the cell heater facing away from the first metallic layer.

14. A cell casing for a battery cell having an integrated cell heater, the cell casing comprising:
a cell heater applied to a first side of a first metallic layer; and
a composite stack comprising at least the first metallic layer and the cell heater,
wherein, in a folded configuration of the composite stack, a second side of the first metallic layer forms an inside of the cell casing.

15. The cell casing according to claim 14, wherein the cell heater has at least one heating layer having at least one resistance heating conductor.

16. The cell casing according to claim 15, wherein the cell heater has at least one electrically insulating film arranged on a respective side of the heating layer.

17. The cell casing according to claim 14, wherein the cell heater rests directly on the first metallic layer.

18. The cell casing according to claim 14, wherein the cell heater rests on the first metallic layer separated by an electrical insulation layer.

19. The cell casing according to claim 14, wherein an electrical insulation layer is arranged on a side of the cell heater facing away from the first metallic layer.

20. The cell casing according to claim 14, further comprising a second metallic layer on a side of the cell heater facing away from the first metallic layer.

21. The cell casing according to claim 20, wherein the cell heater is electrically insulated in relation to the first metallic layer and is connected using a terminal to the second metallic layer.

22. A battery comprising:
a plurality of battery cells, each of the battery cells having a cell casing according to claim 20, wherein the second metallic layers of the cell casings are electrically connected to one another.

23. An electrically operated vehicle comprising:
at least one battery comprising at least one battery cell having a cell casing according to claim 14.

24. The electrically operated vehicle according to claim 23 being a plug-in hybrid vehicle.
